(19) United States
(12) Patent Application Publication
(10) Pub. No.: US 2017/0263373 A1
(43) Pub. Date: Sep. 14, 2017

(54) COIL DEVICE

(71) Applicant: TDK CORPORATION, Tokyo (JP)

(72) Inventors: Syun ASHIZAWA, Tokyo (JP); Toshio TOMONARI, Tokyo (JP); Hirohumi ASOU, Tokyo (JP); Emi ITO, Tsuruoka-city (JP)

(73) Assignee: TDK CORPORATION, Tokyo (JP)

(21) Appl. No.: 15/446,601

(22) Filed: Mar. 1, 2017

(30) Foreign Application Priority Data
Mar. 11, 2016 (JP) 2016-048640

(51) Int. Cl. H01F 27/28; H01F 27/29

(52) U.S. Cl. CPC H01F 27/2823; H01F 27/29

(57) ABSTRACT

A coil device includes a winding core with a coil portion wound by a wire, first and second flanges with open magnetic circuit respectively formed on both sides of the winding core in an axial direction, and a first facing surface of the first flange and a second facing surface of the second flange facing each other in the axial direction on an outer circumference side of the coil portion. S1/S2 is 0.2 to 1.0, where S1 is a maximum lateral cross sectional area of the winding core as seen from the axial direction, and S2 is a projected overlapping area overlapped by the first facing surface and the second facing surface as seen from the axial direction.

### BACKGROUND OF THE INVENTION

1. Field of the Invention

The present invention relates to a coil device having an open magnetic circuit-type core member consisting of a winding core and a pair of flanges.

2. Description of the Related Art

For improvement in magnetic properties, such as inductance, it is common to increase a cross sectional area of a magnetic body as shown in paragraph [0008] of Patent Document 1, for example. In a coil device having an open magnetic circuit-type core member consisting of a winding core and a pair of flanges, it is also conceivable that magnetic properties, such as inductance, are simply improved by increasing a lateral cross sectional area of the winding core.

Patent Document 1: JP 2011-192729A

### SUMMARY OF THE INVENTION

The present invention has been achieved under such circumstances. It is an object of the invention to provide a coil device capable of improving magnetic properties, such as inductance, based on a different principle from conventional ones.

As a result of industrious studies for open magnetic circuit-type coil devices, the present inventors have found out that magnetic properties, such as inductance, can be improved by having a specific ratio between a projected overlapping area of facing surfaces of a pair of flanges and a cross sectional area of a winding core. Then, the present inventors have achieved the present invention.

That is, the coil device according to the present invention is a coil device including:

a winding core with a coil portion wound by a wire;

first and second flanges with open magnetic circuit respectively formed on both sides of the winding core in an axial direction; and

a first facing surface of the first flange and a second facing surface of the second flange facing each other in the axial direction on an outer circumference side of the coil portion,

wherein S1/S2 is 0.2 to 1.0, where S1 is a maximum lateral cross sectional area of the winding core as seen from the axial direction, and S2 is a projected overlapping area overlapped by the first facing surface and the second facing surface as seen from the axial direction.

S1/S2 is preferably 0.3 to 1.0, and is more preferably 0.3 to 0.7. When S1/S2 is in such range, magnetic properties, such as inductance, are improved. The reason why magnetic properties, such as inductance, are improved when S1/S2 is in the above-mentioned range is not necessarily clear, but is conceived as below, for example.

That is, it is conceivable that when the winding core has a small cross sectional area unlike conventional cases, the projected overlapping area overlapped by the first facing surface and the second facing surface becomes relatively large, a spatial magnetic circuit is formed between the facing surfaces facing each other, and its influence becomes large. The above-mentioned improvement in magnetic properties, such as inductance, is particularly remarkably demonstrated when the coil device is small.

Preferably, a total length of the coil device L0=L1+T1+T2 is 10 mm or less, where L1 is a length in the axial direction of the winding core, T1 is a thickness in the axial direction of the first flange, and T2 is a thickness in the axial direction of the second flange. This remarkably demonstrates the effect of the present invention.

Preferably, a smaller one of H1 and H2 is 5 mm or less, and a smaller one of W1 and W2 is 5 mm or less, where H1 is a maximum height of the first flange, H2 is a maximum height of the second flange, W1 is a maximum width of the first flange, and W2 is a maximum width of the second flange. This remarkably demonstrates the effect of the present invention.

### BRIEF DESCRIPTION OF THE DRAWINGS

FIG. 1 is a schematically perspective view of a coil device according to an embodiment of the present invention.

FIG. 2 is a longitudinal cross sectional view of the coil device along the II-II line shown in FIG. 1.

FIG. 3 is a lateral cross sectional view of the coil device along the line shown in FIG. 2.

FIG. 4 is a graph showing a relation between an area S1 of a winding core of a coil device and a projected area S2 of facing surfaces between flanges.

FIG. 5 is a schematically longitudinal cross sectional view of a coil device according to another embodiment of the present invention.

FIG. 6 is a schematically longitudinal cross sectional view of a coil device according to further another embodiment of the present invention.

### DESCRIPTION OF THE PREFERRED EMBODIMENTS

Hereinafter, the present invention will be described based on an embodiment shown in the figures.

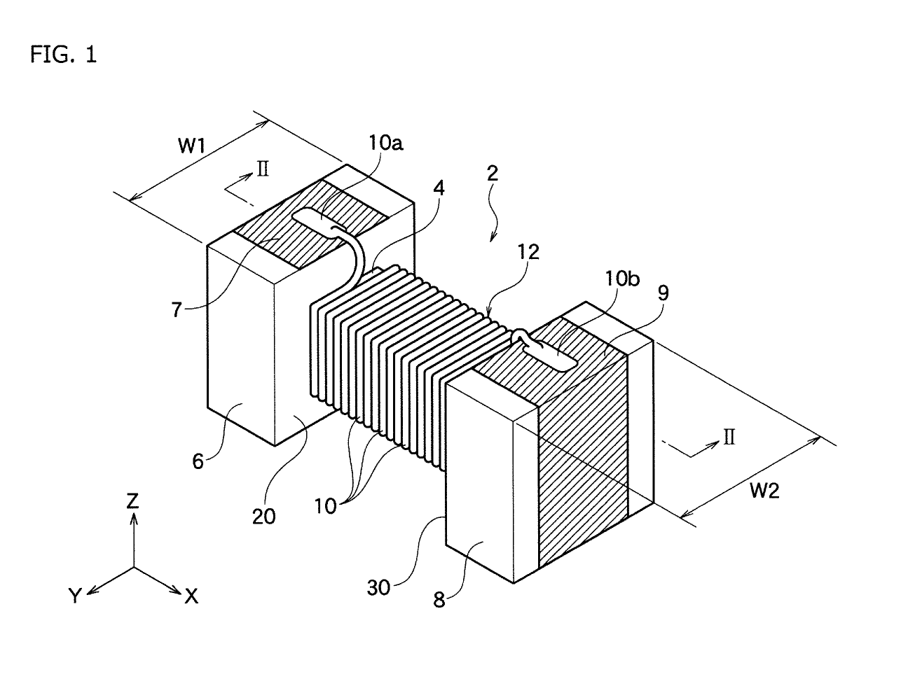

A coil device 2 according to an embodiment of the present invention shown in FIG. 1 is used a signal system coil, such as common mode filter, a power supply system coil, a signal system bead, or the like. The coil device 2 includes a winding core 4 having an axial core in the X-axis direction, and a first flange 6 and a second flange 8 that are open magnetic circuit type and are respectively formed on both sides in the X-axis direction of the winding core 4. Incidentally, the X-axis, the Y-axis, and the Z-axis are vertical to each other in the figures.

An individual or multiple wires 10 are wound around an outer circumference of the winding core 4 by single layer or multiple layers. In the illustrated embodiment, a individual wire 10 is spirally wound around the outer circumference of the winding core 4 by single layer so as to form a coil portion 12, but the present invention is not limited to this embodiment. A first end 10a of the wire 10 is electrically connected to a first terminal electrode 7 formed on an outer surface of the first flange 6 and is fixed. A second end 10b positioned opposite to the first end 10a of the wire 10 is electrically connected to a second terminal electrode 9 formed on an outer surface of the second flange 8 and is fixed.

The wire 10 may be any wire, such as resin coated wire. The wire 10 has any diameter, but preferably has a diameter of 0.01 to 0.1 mm.

The winding core 4 and the pair of flanges 6 and 8 are integrally formed as a drum core, and may be constituted by a magnetic body such as ferrite and metal magnetic body or by a nonmagnetic body such as alumina. The drum core is constituted by a magnetic body material whose specific permeability μ is preferably 50 or more, more preferably 100 or more, and particularly preferably 200 or more.

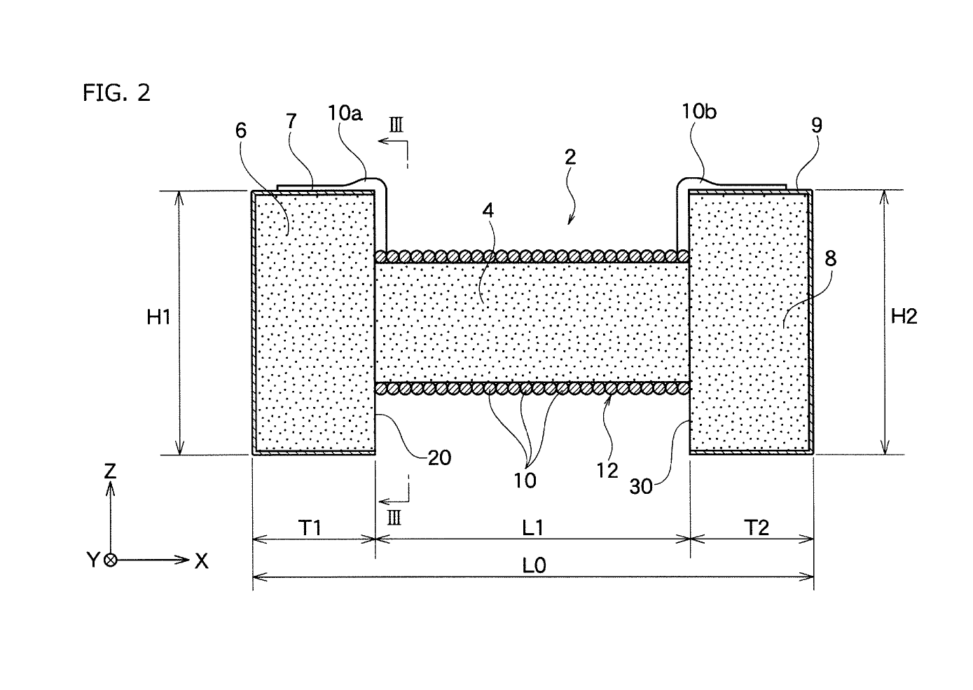

In the present embodiment, the coil device 2 has any size, but the coil device 2 having a small size is effective. For example, as shown in FIG. 2, a total length of the coil device 2 L0=L1+T1+T2 is preferably 10 mm or less, where L1 is a length in the X-axis direction of the winding core 4, T1 is a thickness in the X-axis direction of the first flange 6, and T2 is a thickness in the X-axis direction of the second flange 8. The total length L0 is more preferably 0.4 to 10.0 mm. This remarkably demonstrates the following effect.

As shown in FIG. 2, a smaller one of H1 and H2 is 5 mm or less, and a smaller one of W1 and W2 is 5 mm or less, where H1 is a maximum height (Z-axis direction) of the first flange 6, H2 is a maximum height of the second flange 8, W1 is a maximum width (Y-axis direction) of the first flange 6, and W2 is a maximum width of the second flange 8.

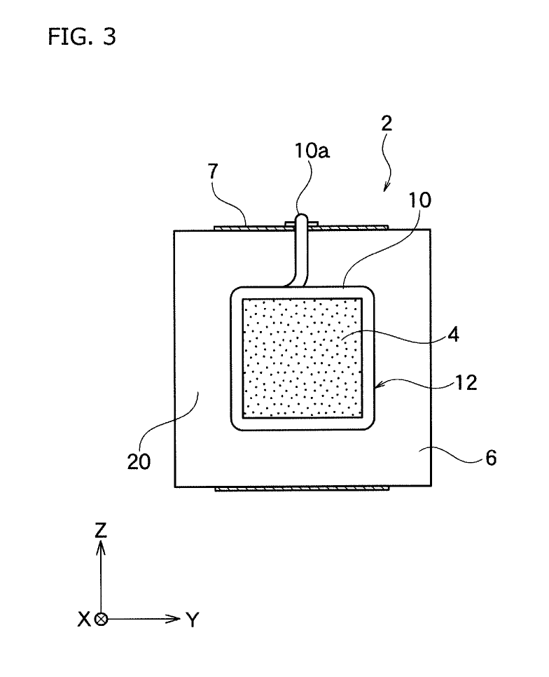

In the present embodiment, as shown in FIG. 3, the first flange 6 has a large length in the Y-axis and Z-axis directions in comparison with a lateral cross sectional view of the winding core 4, and a first facing surface 20 with a comparatively large area is formed on an inner surface (winding core side) of the first flange 6 on an outer circumference side of the coil portion 12. FIG. 3 illustrates only the first facing surface 20, but a second facing surface 30 facing the first facing surface 20 in the X-axis direction is similarly formed on an inner surface of the second flange 8 shown in FIG. 1 and FIG. 2.

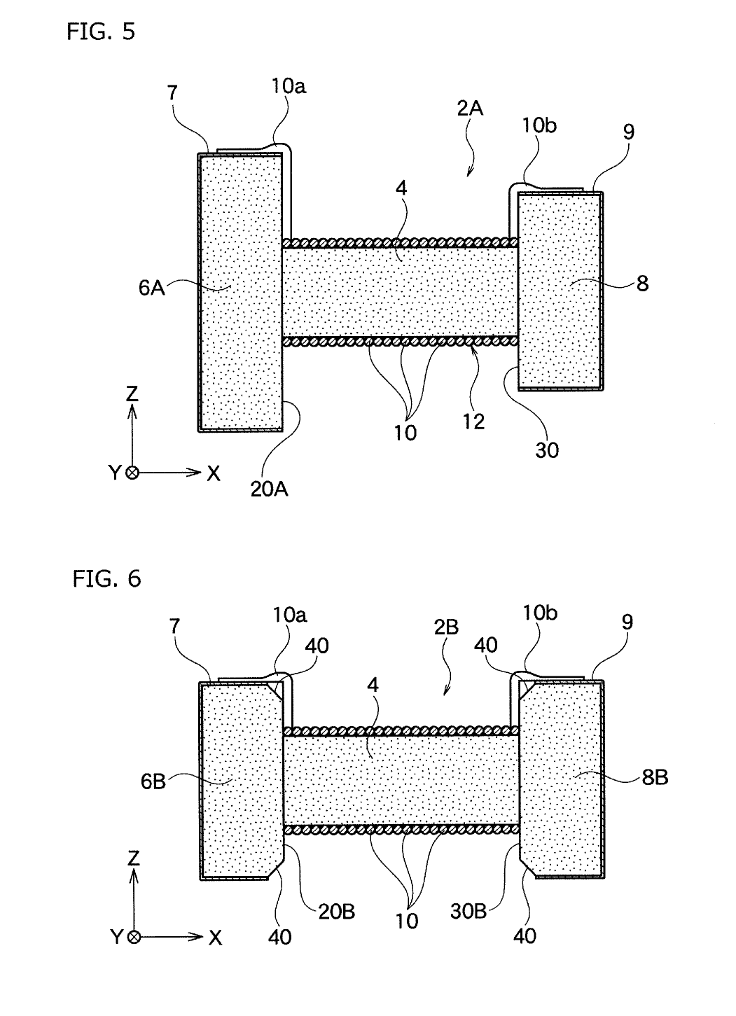

The first facing surface 20 and the second facing surface 30 respectively has the same area in the present embodiment, but as shown in a coil device 2A shown in FIG. 5, a first flange 6A may have a large size in the Y-axis direction and/or the Z-axis direction, and a first facing surface 20A may have a larger area than an area of the second facing surface 30. Instead, the second surface may have a larger area than an area of the first facing surface.

For example, as shown in a coil device 2B shown in FIG. 6, a chamfering part 40 inclined toward a plane surface parallel to the Z-axis and the Y-axis, another inclined surface, a curved surface such as R part, or the like, may be formed on at least one of a first facing surface 20B of a first flange 6B and a second facing surface 30B of a second flange 8B.

Furthermore, the winding core 4 has a lateral cross section of an approximately square shape in the present embodiment, but has any lateral cross sectional shape, such as another polygon, a circle, an ellipse, and another shape. A lateral cross section of the flanges 6 and 8 is not limited to a square either, but may be another polygon, a circle, an ellipse, and another shape.

The thickness in the X-axis direction of the first flange 6 and the thickness in the X-axis direction of the second flange 8 shown in FIG. 2 may be the same or different, and are a thickness capable of maintaining strength. The winding core 4 has a lateral cross sectional area that does not change along the X-axis direction in the present embodiment, but the lateral cross sectional area may change to be largest in the middle part in the X-axis direction, for example.

In any case, in the present embodiment, S1/S2 is 0.2 to 1.0, S1/S2 is preferably 0.3 to 1.0, and S1/S2 is more preferably 0.3 to 0.7, where S1 is a maximum lateral cross sectional area of the winding core 4 as seen from the X-axis direction, and S2 is a projected overlapping area overlapped by the first facing surface 20 and the second facing surface 30 facing each other in the X-axis direction on the outer circumference side of the coil portion 12 as seen from the X-axis direction.

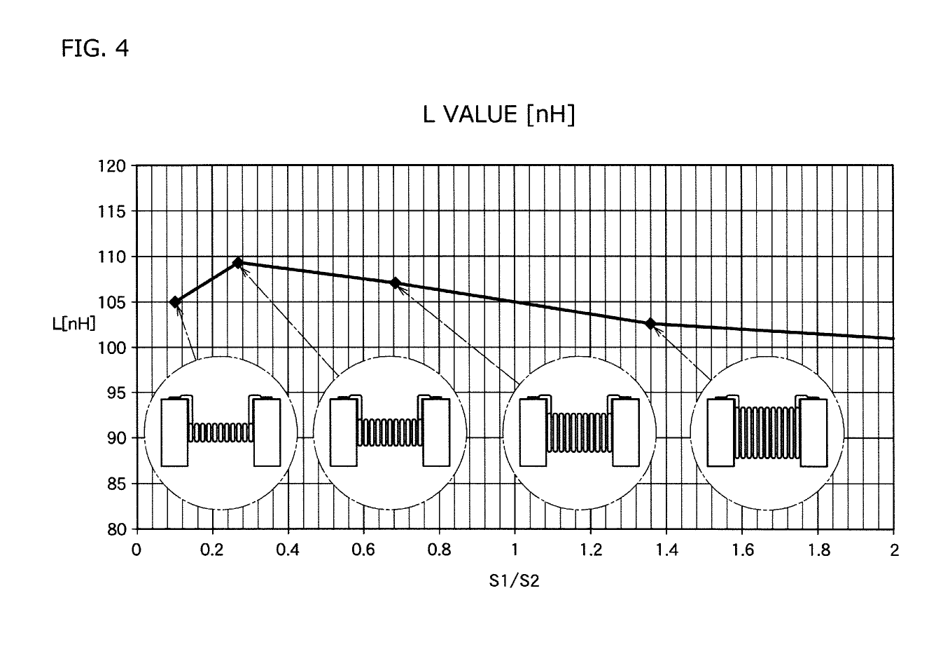

As shown in FIG. 4, magnetic properties, such as inductance L, are improved when S1/S2 is in the above-mentioned range. Incidentally, when S1/S2 is too small, a lateral cross sectional area of the winding core tends to be too small, and a mechanical strength tends to decrease too much. Incidentally, the reason why magnetic properties, such as inductance, are improved when S1/S2 is in the above-mentioned range is not necessarily clear, but is conceived as below, for example.

That is, it is conceivable that when the winding core 4 has a small cross sectional area unlike conventional cases, a projected overlapping area overlapped by the first facing surface 20 and the second facing surface 30 becomes relatively large, a spatial magnetic circuit is formed between the facing surfaces 20 and 30 facing each other, and its influence becomes large. The above-mentioned improvement in magnetic properties, such as inductance, is particularly remarkably demonstrated when the coil devices 2, 2A, and 2B are small.

Incidentally, FIG. 4 shows results performed in the following conditions. That is, the following drum core is prepared: widths in the Y-axis direction of the flanges 6 and 8 shown in FIG. 1 are W1=W2=0.33 mm; and L1=0.44 mm, T1=T2=0.13 mm, and H1=H2=0.43 mm shown in FIG. 2.

The wire 10 is a polyurethane copper wire having a diameter of φ0.01 to φ0.1 mm and is wound around the winding core 4 by single layer. Except for changing a maximum lateral cross sectional area S1 of the winding core 4, samples of similar coil devices are made, and inductance L of each coil device sample is measured using an impedance analyzer. The results are shown in FIG. 4.

Incidentally, the present invention is not limited to the above-mentioned embodiment, but may be variously changed within the scope of the present invention.

### NUMERICAL REFERENCES

2, 2A, 2B . . . coil device

4 . . . winding core

6, 6A, 6B . . . first flange

7 . . . first terminal electrode

8, 8B . . . second flange

9 . . . second terminal electrode

10 . . . wire

12 . . . coil portion

20, 20A, 20B . . . first facing surface

30, 30B . . . second facing surface

40 . . . chamfering part

1. A coil device comprising:
a winding core with a coil portion wound by a wire;
first and second flanges with open magnetic circuit respectively formed on both sides of the winding core in an axial direction; and
a first facing surface of the first flange and a second facing surface of the second flange facing each other in the axial direction on an outer circumference side of the coil portion,
wherein S1/S2 is 0.2 to 1.0, where S1 is a maximum lateral cross sectional area of the winding core as seen from the axial direction, and S2 is a projected overlapping area overlapped by the first facing surface and the second facing surface as seen from the axial direction.

2. The coil device according to claim 1, wherein a total length of the coil device L0=L1+T1+T2 is 10 mm or less, where L1 is a length in the axial direction of the winding core, T1 is a thickness in the axial direction of the first flange, and T2 is a thickness in the axial direction of the second flange.

3. The coil device according to claim 1, wherein a smaller one of H1 and H2 is 5 mm or less, and a smaller one of W1 and W2 is 5 mm or less, where H1 is a maximum height of the first flange, H2 is a maximum height of the second flange, W1 is a maximum width of the first flange, and W2 is a maximum width of the second flange.

4. The coil device according to claim 2, wherein a smaller one of H1 and H2 is 5 mm or less, and a smaller one of W1 and W2 is 5 mm or less, where H1 is a maximum height of the first flange, H2 is a maximum height of the second flange, W1 is a maximum width of the first flange, and W2 is a maximum width of the second flange.
